(19) United States
(12) Patent Application Publication
(10) Pub. No.: US 2026/0171596 A1
(43) Pub. Date: Jun. 18, 2026

(54) BATTERY PACK AND A VEHICLE COMPRISING THEREOF

(71) Applicant: Ford Global Technologies, LLC, Dearborn, MI (US)

(72) Inventors: Fei Gao, Nanjing (CN); Robin Zhou, Nanjing (CN); Larry Wang, Nanjing (CN)

(21) Appl. No.: 19/410,217

(22) Filed: Dec. 5, 2025

(30) Foreign Application Priority Data
Dec. 12, 2024 (CN) 2024118325919

(51) Int. Cl. H01M 50/358; B60L 50/64; H01M 50/204; H01M 50/249; H01M 50/271; H01M 50/342

(52) U.S. Cl. CPC H01M 50/358; B60L 50/64; H01M 50/204; H01M 50/249; H01M 50/271; H01M 50/3425; H01M 2220/20

(57) ABSTRACT

A vehicle battery pack comprises an upper cover, a tray, and a battery cell located within a space defined collectively by the upper cover and the tray. The battery cell has a first side surface provided with a cell exhaust vent or facing the cell exhaust vent. The upper cover, the tray, or both comprises a first side portion adjacent to a second side surface of the battery cell. The first side surface is adjacent to the second side surface. The first side portion is provided with a first ventilation channel for collecting exhaust gas from the battery cell. At least a portion of the first ventilation channel is isolated from the battery cell.

### CROSS-REFERENCE TO RELATED APPLICATIONS

This disclosure claims priority to Chinese Patent Application No. 202411832591.9, which was filed on Dec. 12, 2024, and is incorporated herein by reference in its entirety.

### TECHNICAL FIELD

This disclosure generally relates to a battery pack and a vehicle comprising thereof.

### BACKGROUND

With technological development, the demand for electrical power in various electrical devices continues to increase. For example, for vehicles, increased driving range requirements, increased types and quantities of in-vehicle equipment, etc., all lead to an increase in the overall power demand of the vehicle, which makes the battery pack used to provide power larger in size and more complex internal structures. The interior of a battery pack typically contains many battery cells, which may generate gas under certain conditions. To address the issue of gas emission, various technical solutions have been proposed.

For example, patent document CN117751489A discloses a battery module including a plurality of battery cell assemblies, a lower battery module housing, and an upper battery module housing. The lower battery module housing has an open upper surface and accommodates the plurality of battery cell assemblies. The upper battery module housing is coupled to the open upper surface of the lower battery module housing. The upper battery module housing includes a gas inlet through which gas generated in the battery module is introduced and a first gas channel communicating with the gas inlet. The lower battery module housing includes a sidewall frame. The sidewall frame includes a second gas channel communicating with the first gas channel and a gas outlet communicating with the second gas channel to discharge the gas to the outside.

### SUMMARY

The present disclosure summarizes aspects of the embodiments and should not be used to limit the claims. Other implementations are contemplated in accordance with the techniques described herein, as will be apparent to those skilled in the art upon examination of the following drawings and detailed description, and such implementations are intended to be within the scope of this application.

The inventors of the present application have recognized the need for a battery pack and a vehicle comprising thereof that can provide a smooth discharge path for gas generated inside the battery pack while making the overall structure of the battery pack as compact as possible, thereby improving user satisfaction.

An aspect of the present disclosure provides a battery pack, comprising:
an upper cover and a tray; and
a battery cell located within a space defined collectively by the upper cover and the tray, wherein the battery cell has a first side surface provided with a cell exhaust vent or facing the cell exhaust vent; and
wherein the upper cover and/or the tray comprises a first side portion adjacent to a second side surface of the battery cell, the first side surface is adjacent to the second side surface, the first side portion is provided with a first ventilation channel for collecting exhaust gas from the battery cell, and at least a portion of the first ventilation channel is isolated from the battery cell.

According to an embodiment of the present disclosure, the battery cell forms part of a first battery array, the battery pack further comprises a second battery array, the upper cover and/or the tray further comprises a second side portion abutting the second battery array, the first ventilation channel extends to the second side portion, a second ventilation channel is formed between the first battery array and the second battery array, the first side surface of the battery cell of the first battery array faces the second ventilation channel, and the second ventilation channel is at an angle to the first ventilation channel and communicates with the first ventilation channel.

According to an embodiment of the present disclosure, a first heat insulation plate is provided on a side of the first battery array and the second battery array facing the second ventilation channel.

According to an embodiment of the present disclosure, the battery pack further comprises a bridge plate, wherein the first battery array and the second battery array respectively comprise a first end plate and a second end plate, the first end plate and the second end plate are connected by the bridge plate, and the bridge plate closes an end of the second ventilation channel.

According to an embodiment of the present disclosure, the first battery array and the second battery array are supported on the tray via the bridge plate.

According to an embodiment of the present disclosure, the bridge plate comprises a first part closing the end of the second ventilation channel, a second part connected to the first part at an angle, and a support rib connected to both the first part and the second part at an angle, and the second part is supported on the tray.

According to an embodiment of the present disclosure, the first side portion and the second side portion are located on the upper cover, and second heat insulation plates are respectively provided between the upper cover and the first battery array as well as between the upper cover and the second battery array.

According to an embodiment of the present disclosure, the upper cover comprises a first plate and several second plates, each of the second plates abuts one of the first battery array and the second battery array, and the first plate and the second plates enclose to form at least a portion of the first ventilation channel.

According to an embodiment of the present disclosure, the second ventilation channel is located between adjacent second plates and is at least partially defined by the first plate.

According to an embodiment of the present disclosure, the battery pack further comprises a vent valve, wherein the first ventilation channel communicates with the vent valve.

According to an embodiment of the present disclosure, the battery pack further comprises a first chamber provided between the first ventilation channel and the vent valve.

According to an embodiment of the present disclosure, the first chamber comprises a first cover plate for separating the first chamber from a battery control unit, and a second cover plate for separating the first chamber from external environment.

According to an embodiment of the present disclosure, the battery pack further comprises a cover plate covering the vent valve, and the cover plate comprises an air passage communicating the vent valve with external environment.

According to an embodiment of the present disclosure, the air passage is located on a side of the cover plate and is inclined downward.

According to an embodiment of the present disclosure, the first chamber is located at a longitudinal end of the battery pack, and the vent valve is located on a wall of the first chamber facing the longitudinal exterior.

According to an embodiment of the present disclosure, the first battery array comprises a first side plate connected to the first end plate, the second battery array comprises a second side plate connected to the second end plate, and the bridge plate passes through the first end plate and the second end plate respectively to connect to the first side plate and the second side plate.

Another aspect of the present disclosure provides a vehicle comprising a battery pack as any one of the above embodiments.

Yet another aspect of the present disclosure provides a vehicle comprising a battery pack, wherein the battery pack comprises:
a first battery array comprising several battery cells; and
an upper cover located above the first battery array in a vehicle vertical direction, the upper cover comprising a first side portion adjacent to an upper side surface of the several battery cells in the first battery array,
wherein the first side portion is provided with a first ventilation channel for collecting exhaust gas from the battery cells, and at least a portion of the first ventilation channel is isolated from the first battery array in the vehicle vertical direction.

According to an embodiment of the present disclosure, the battery pack further comprises a vent valve located at an end in a vehicle longitudinal direction, and the first ventilation channel communicates with the vent valve via a first chamber.

According to an embodiment of the present disclosure, the first chamber comprises a first cover plate for separating the first chamber from a battery control unit, and a second cover plate for separating the first chamber from external environment.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

In order to better understand the present disclosure, reference can be made to the embodiments shown in the following drawings. The components in the drawings may not necessarily be drawn to scale, and relevant components may be omitted, or in some cases, the scale may have been enlarged to emphasize and clearly illustrate the novel features described in this disclosure. Additionally, as known in the art, system components can be arranged differently. Further in the figures, like reference numbers refer to like parts throughout the different figures.

FIG. 1 illustrates a schematic diagram of a vehicle comprising a battery pack according to one or more embodiments of the present disclosure;

FIG. 2 illustrates a perspective view of a battery pack from a side perspective according to one or more embodiments of the present disclosure;

FIG. 3 illustrates an exploded view of a battery pack according to one or more embodiments of the present disclosure, showing a state where an upper cover is separated from a tray;

FIG. 4 illustrates a perspective view of a battery pack from a rear perspective according to one or more embodiments of the present disclosure;

FIG. 5 illustrates an exploded view of a battery pack according to one or more embodiments of the present disclosure, showing a state where a second cover plate is separated;

FIG. 6 illustrates an exploded view of a battery pack according to one or more embodiments of the present disclosure, showing a state where a first cover plate and a second cover plate are separated;

FIG. 7 illustrates a schematic diagram of an upper cover of a battery pack according to one or more embodiments of the present disclosure;

FIG. 8 illustrates a schematic diagram of a first plate of an upper cover of a battery pack according to one or more embodiments of the present disclosure;

FIG. 9 illustrates a partial cross-sectional view of an upper cover of a battery pack according to one or more embodiments of the present disclosure, showing the relative positions of a first plate and a second plate;

FIG. 10 illustrates a transverse cross-sectional view of an upper cover of a battery pack according to one or more embodiments of the present disclosure;

FIG. 11 illustrates a perspective view of a battery pack with an upper cover removed according to one or more embodiments of the present disclosure;

FIG. 12 illustrates a perspective view of a bridge plate of a battery pack according to one or more embodiments of the present disclosure;

FIG. 13 illustrates a partial perspective view of a battery pack with an upper cover removed according to one or more embodiments of the present disclosure;

FIG. 14 illustrates a partial transverse cross-sectional view of a battery pack according to one or more embodiments of the present disclosure;

FIG. 15 illustrates a partial transverse cross-sectional view of a battery pack according to one or more embodiments of the present disclosure, where the position of a battery cell is indicated by dashed lines;

FIG. 16 illustrates a schematic diagram of the relative position between a battery cell and a cell vent in a battery pack according to yet another one or more embodiments of the present disclosure;

FIG. 17 illustrates a schematic diagram of a vehicle including a battery pack according to another one or more embodiments of the present disclosure;

FIG. 18 illustrates a partial exploded view of a battery pack according to another one or more embodiments of the present disclosure, showing a state where an upper cover is separated from a tray;

FIG. 19 illustrates a partial exploded view of a battery pack according to another one or more embodiments of the present disclosure, showing a state where a first cover plate and a second cover plate are separated;

FIG. 20 illustrates a schematic diagram of an upper cover of a battery pack according to another one or more embodiments of the present disclosure; and

FIG. 21 illustrates a partial transverse cross-sectional view of a battery pack according to another one or more embodiments of the present disclosure, where the position of a battery cell is indicated by dashed lines.

### DETAILED DESCRIPTION

Embodiments of the present disclosure are described below. However, it is to be understood that the disclosed embodiments are merely examples and other embodiments may take various and alternative forms. The figures are not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features shown in one or more other figures to produce embodiments not expressly shown or described. The combinations of features shown herein provide representative embodiments for typical applications. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

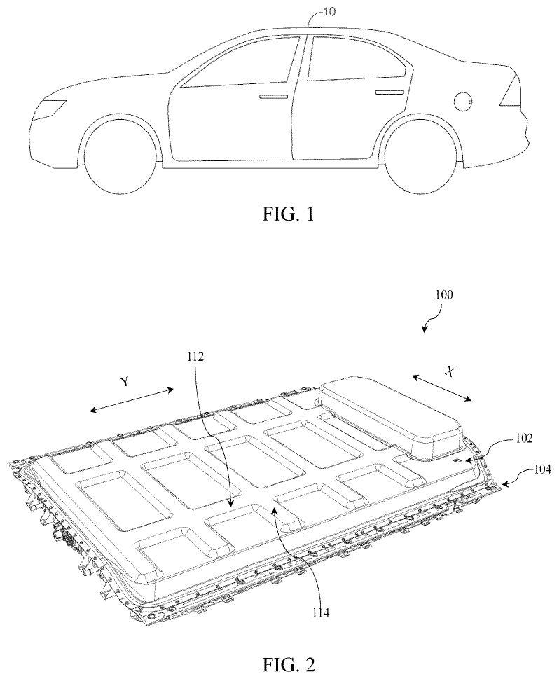

Firstly, FIG. 1 illustrates a schematic diagram of a vehicle 10 that can use a battery pack according to one or more embodiments of the present disclosure. It should be understood that in the context of the present disclosure, the vehicle 10 implementing the present disclosure may refer to any vehicle containing a battery pack, such as comprising, but not limited to fossil fuel vehicles, electric vehicles (such as plug-in hybrid electric vehicles (PHEVs), fully hybrid electric vehicles (FHEVs), mild hybrid electric vehicles (MHEVs), or battery electric vehicles (BEVs)), or even ships, aircraft, etc. The vehicle 10 may include components related to mobility, such as an engine, an electric motor, a transmission, a suspension, a drive shaft, and/or wheels, and the like. The vehicle 10 may be non-autonomous, semi-autonomous (e.g., some conventional movement functions autonomously controlled by the vehicle) or autonomous (e.g., motion functions autonomously controlled by the vehicle without direct input from the user).

FIG. 2 is a perspective view of a battery pack 100 according to one or more embodiments of the present disclosure. As shown in the figure, the battery pack 100 includes a housing composed of an upper cover 102 and a lower tray 104, and a plurality of reinforcing structures and connection positions can be provided around the housing, which are omitted here and will not be marked and described one by one for brevity.

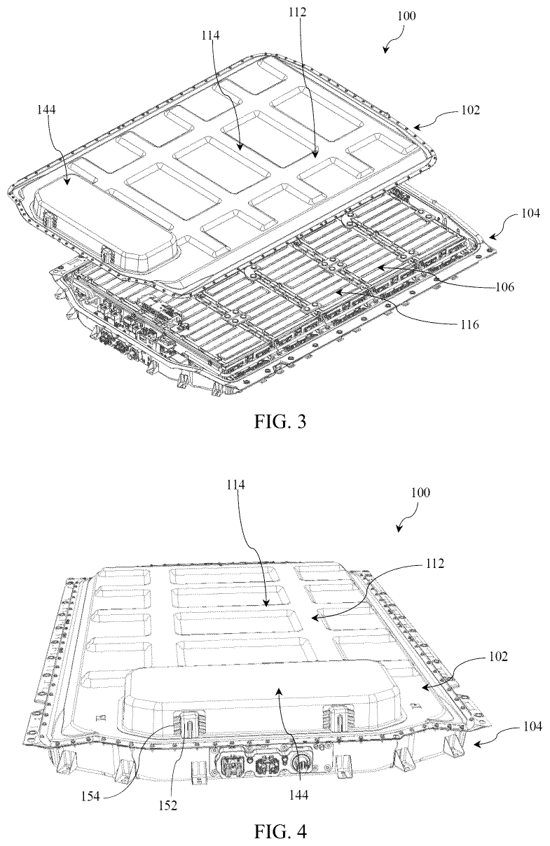

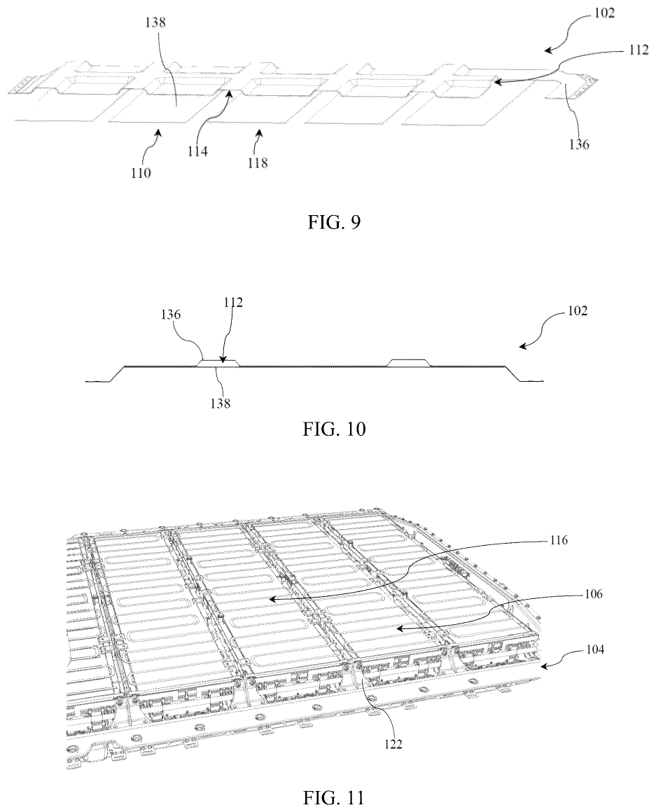

Next referring generally to FIGS. 3 to 15, one aspect of the present disclosure provides a battery pack 100 comprising an upper cover 102, a tray 104 and a battery cell 108. The battery cell 108 is located within a space defined collectively by the upper cover 102 and the tray 104, for example, a closed space formed by the upper cover 102 and the tray 104 enclosing from above and below. A first side surface 160 of the battery cell 108 may be provided with a cell exhaust vent 140. At least one of the upper cover 102 and the tray 104 may comprise a first side portion 110 adjacent to a second side surface 162 of the battery cell 108. The first side surface 160 of the battery cell 108 is adjacent to the second side surface 162, as shown in FIG. 15. The first side portion 110 is provided with a first ventilation channel 112, the first ventilation channel 112 is for collecting exhaust gas from the battery cell 108, and at least a portion of the first ventilation channel 112 is isolated from the battery cell 108. In some embodiments of the present disclosure, the first ventilation channel 112 may comprise a plurality of channels arranged side by side and spaced apart by a certain distance, and the specific number of channels can be set and adjusted according to structural requirements.

In this embodiment, at least a portion of the first ventilation channel 112 is isolated from the battery cell 108, so that at this portion of the first ventilation channel 112, the gas inside the channel is separated from the battery cell 108. In one embodiment, this can be achieved by arranging this portion of the first ventilation channel 112 inside the first side portion 110. Furthermore, the first side surface 160 of the battery cell 108 is adjacent to the second side surface 162, so that the first side surface 160 and the second side surface 162 have an intersecting line. The cell exhaust vent 140 in this embodiment can be understood as a location that allows gas to discharge when the battery cell vents, including but not limited to an opening, a score line, or any weak part on an entire side surface.

Unlike the prior art where the gas discharge part and the gas guide part of the battery cell are arranged on one side surface or the gas guide part is set as an independent side part, in the embodiment of the battery pack 100, the discharge location for gas that may be generated during operation of the battery cell 108 is arranged on the side of the first side surface 160 of the battery cell 108, the first ventilation channel 112 responsible for collecting and guiding the exhaust gas from the battery cell 108 is arranged on the side of the second side surface 162 of the battery cell 108, and the first side surface 160 and the second side surface 162 are made adjacent to each other, or in other words, the two side surfaces intersect. This can save the size of the battery pack in the direction faced by the second side surface 162 to a certain extent while allowing smooth gas discharge, improving space utilization.

In some embodiments of the present disclosure, the battery pack 100 may further comprise a vent valve 142, as shown in FIG. 6. The first ventilation channel 112 communicates with the vent valve 142, and the vent valve 142 further communicates with the external environment. This arrangement allows the exhaust gas collected through the first ventilation channel 112 from inside the battery pack 100 to be ultimately discharged to the external environment through the vent valve 142. In some further embodiments, the battery pack 100 may further comprise a first chamber 144. The first chamber 144 is provided between the first ventilation channel 112 and the vent valve 142, as shown in FIGS. 4 to 6. The first chamber 144 can collect exhaust gas from the entire interior of the battery pack 100 and ultimately distribute it to one or more vent valves 142 for discharge to the external environment. In some embodiments, the first chamber 144 may be located at a longitudinal end of the battery pack 100, and the vent valve 142 is located on a wall of the first chamber 144 facing longitudinally outward, thereby facilitating the guidance of the exhaust gas inside the battery pack 100 through the first ventilation channel 112 to the end and discharging it at the vent valve 142, while the side wall of the first chamber 144 also provides sufficient installation space for the vent valve 142.

As shown in FIGS. 4 to 6, the battery pack 100 may further comprise a cover plate 152 covering the vent valve 142. The cover plate 152 is provided with an air passage 154, which can communicate the vent valve 142 with the external environment. The arrangement of the cover plate 152 can provide a certain level of protection for the vent valve 142 inside it, preventing it from being approached by splashing liquid or debris, which could affect the venting effect. In some further embodiments, the air passage 154 may be located on a side of the cover plate 152 and inclined downward, which can guide the gas discharged from the vent valve 142 downward, keeping it away from components located above the battery pack 100 in the installed state.

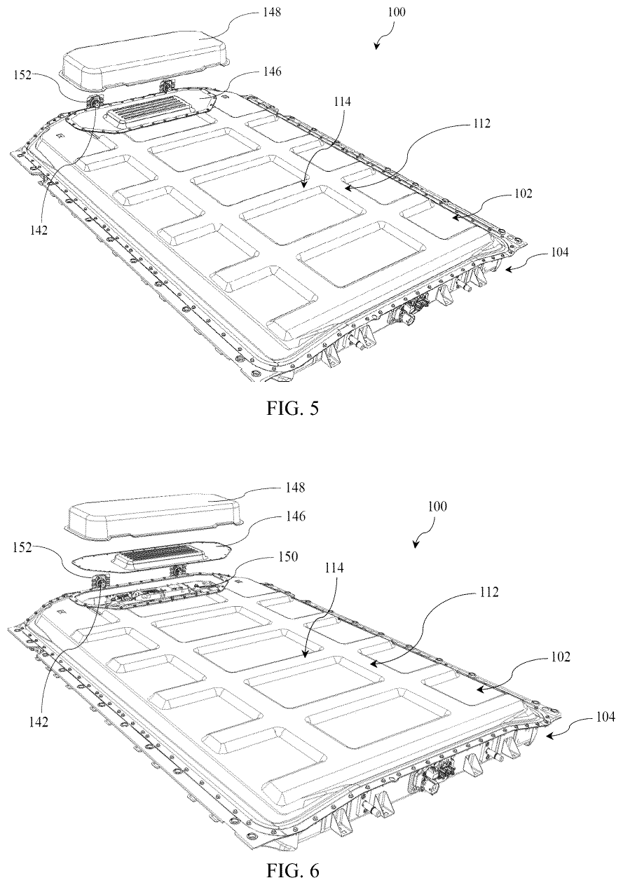

According to several further embodiments of the present disclosure, the battery pack 100 may further comprise a battery control unit 150 for battery management, referring to FIGS. 5 and 6. The first chamber 144 may be adjacent to the battery control unit 150 and comprise a first cover plate 146 and a second cover plate 148. The first cover plate 146 separates the first chamber 144 from the battery control unit 150, and the second cover plate 148 separates the first chamber 144 from the external environment. The arrangement of the first cover plate 146 and the second cover plate 148 can provide maintenance access to the battery control unit 150 when needed, while also providing isolation means for the battery control unit 150 to protect it from the effects of exhaust gas. It can be understood that the battery control unit 150 may comprise a high-voltage control unit, a low-voltage control unit, and other possible electronic components.

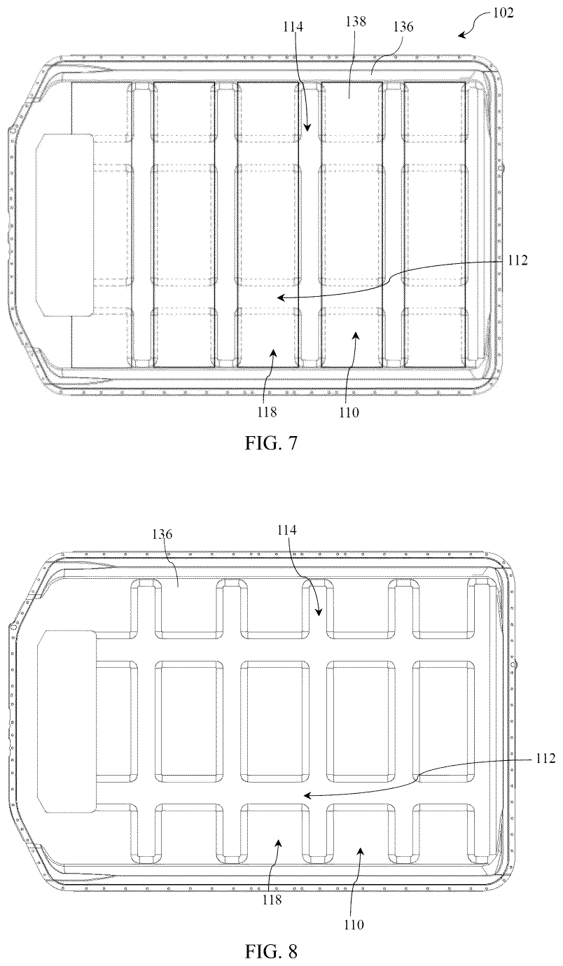

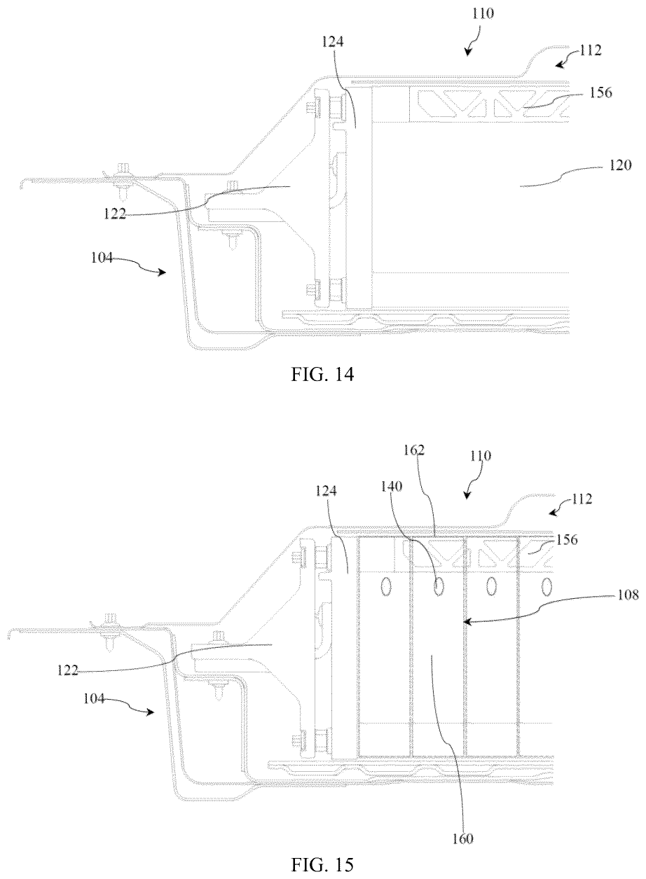

In one or more embodiments of the present disclosure, referring to FIGS. 7 to 11, the battery cell 108 may form part of a first battery array 106. The battery pack 100 may further comprise a second battery array 116, which may have the same or similar structure as the first battery array 106. At least one of the upper cover 102 and the tray 104 that comprises the first side portion 110 may further comprise a second side portion 118 abutting the second battery array 116, and the first ventilation channel 112 extends to the second side portion 118. A second ventilation channel 114 is formed between the first battery array 106 and the second battery array 116, which can be further referred to FIG. 13. The first side surface 160 of the battery cell 108 of the first battery array 106 faces the second ventilation channel 114, and the second ventilation channel 114 is at an angle to and communicates with the first ventilation channel 112. It can be understood that this angle is not limited to the 90-degree angle shown in the figure, but can be set to a larger or smaller angle according to the structure of the battery pack and specific requirements. In this arrangement, the second ventilation channel 114 is formed between the adjacent first battery array 106 and second battery array 116 to collect exhaust gas from the battery cells of both and the exhaust gas is guided for discharge through the first ventilation channel 112 communicating with the second ventilation channel 114 at an angle, which can better utilize the internal space of the battery pack 100 to form a ventilation channel network for gas collection and discharge. In a further embodiment, a first heat insulation plate 120 is provided on the side of the first battery array 106 and the second battery array 116 facing the second ventilation channel 114, referring to FIG. 14. This can provide a certain thermal isolation effect for the battery cells inside the first battery array 106 and the second battery array 116. The first heat insulation plate 120 may comprise any material that provides the desired thermal isolation effect, such as but not limited to materials containing mica, ceramic, silicone, etc. In some embodiments, the first heat insulation plate 120 may be provided with openings communicating with the cell exhaust vent 140, which can be selectively opened under different pressure conditions to discharge internal gas.

In several embodiments of the present disclosure, referring to FIG. 7, the first side portion 110 and the second side portion 118 may be located on the upper cover 102, placing the first ventilation channel 112 above the first battery array 106 and the second battery array 116. Second heat insulation plates 134 are respectively provided between the upper cover 102 and the first battery array 106, as well as between the upper cover 102 and the second battery array 116, as shown in FIG. 13. This can provide thermal isolation for the battery cells inside the first battery array 106 and the second battery array 116 against the gas in the first ventilation channel 112.

According to some further embodiments of the present disclosure, the upper cover 102 may comprise a first plate 136 and several second plates 138, as shown in FIGS. 7 to 9. Each second plate 138 abuts one of the first battery array 106 and the second battery array 116. The first plate 136 and the second plates 138 enclose to form at least a portion of the first ventilation channel 112. As shown in the figures, the first ventilation channel 112 can be formed by a portion of the first plate 136 arched upward in an arc shape together with the second plates 138. This arrangement places at least a portion of the first ventilation channel 112 inside the upper cover 102 through a local double-layer structure, simplifying the required structure. According to a further embodiment, the second ventilation channel 114 may be located between adjacent second plates 138 and is at least partially defined by the first plate 136, as shown in FIG. 7. This arrangement can achieve the communication structure between the first ventilation channel 112 and the second ventilation channel 114 with a simplified structure.

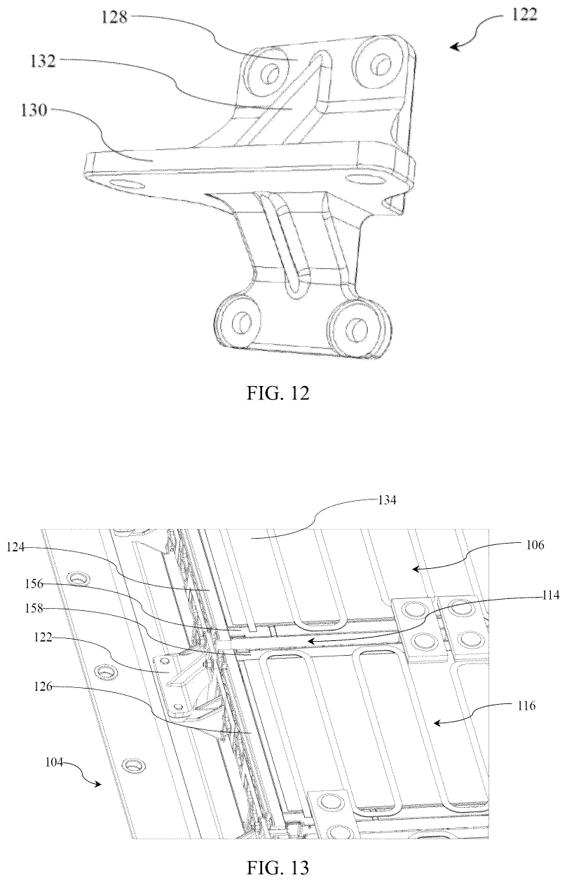

Referring to FIGS. 12 to 15, in several embodiments of the present disclosure, the battery pack 100 may further comprise a bridge plate 122. The first battery array 106 comprises a first end plate 124 provided at its end, and the second battery array 116 comprises a second end plate 126 provided at its end. The first end plate 124 and the second end plate 126 are connected by the bridge plate 122, and the bridge plate 122 closes an end of the second ventilation channel 114. The bridge plate 122 can form a barrier to the gas within the second ventilation channel 114, preventing it from entering other parts of the battery pack 100 through this end, and instead directing it into the first ventilation channel 112 communicating with the second ventilation channel 114 for discharge through this path. It can be understood that similar or identical structures may also be included at the opposite ends of the first battery array 106 and the second battery array 116, which are not repeated here for brevity.

In some further embodiments of the present disclosure, the first battery array 106 and the second battery array 116 may be supported on the tray 104 via the bridge plate 122, referring to FIGS. 13 to 15, thereby assisting in supporting the weight of the first battery array 106 and the second battery array 116 onto the tray 104, thus stabilizing the overall structure.

According to several further embodiments, referring to FIG. 12, the bridge plate 122 may comprise a first part 128, a second part 130, and a support rib 132. The first part 128 forms the part that closes the end of the second ventilation channel 114. The second part 130 is connected at an angle—for example, but not limited to, 90 degrees—to the first part 128 and is supported on the tray 104. The first part 128 and the second part 130 form the main body of the bridge plate 122. The support rib 132 is connected at angles to both the first part 128 and the second part 130, for example, but not limited to, 90 degrees, which can stabilize the overall structure of the bridge plate 122 and provide stable support between them.

Referring to FIG. 13, in several embodiments of the present disclosure, the first battery array 106 may comprise a first side plate 156 located at the side of the battery cell, the first side plate 156 being connected to the first end plate 124 at the end of the first battery array 106. The second battery array 116 may comprise a second side plate 158 located at the side of the battery cell, the second side plate 158 being connected to the second end plate 126 at the end of the second battery array 116. It can be understood that similar or identical structures may also be included on the opposite sides of the first battery array 106 and the second battery array 116, which are not repeated here for brevity. The bridge plate 122 may pass through the first end plate 124 and the second end plate 126 respectively to connect to the first side plate 156 and the second side plate 158, for example, via double-ended studs passing through the bridge plate 122 and the first and second end plates 124, 126 and into the first and second side plates 156, 158 for connection. This arrangement can form an H-shaped frame structure, providing stable support for the overall battery pack 100. When the battery pack 100 is applied in a vehicle, this structure can transfer loads in the event of a loading event where a load is applied to the H-shaped frame structure formed by the bridge plate 122, the first and second end plates 124, 126, and the first and second side plates 156, 158, etc.

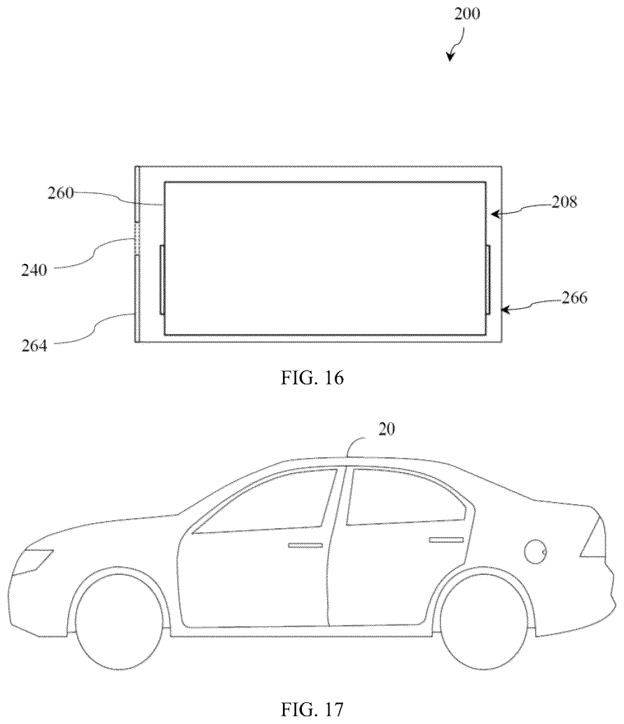

According to another aspect of the present disclosure, and referring to FIG. 16, a battery pack 200 is provided. For the sake of brevity, only some features of the battery pack 200 are described below; where compatible, other features of the battery pack 200 can be referred to the foregoing description regarding the battery pack 100. The difference from the battery pack 100 is that, in the embodiment of the battery pack 200, the cell exhaust vent 240 may not be located on the first side surface 260 of the battery cell 208 of the battery pack 200, but is instead formed on an independent element, for example, located on a side wall 264, and the first side surface 260 of the battery cell 208 faces this side wall 264. In several embodiments, the side wall 264 may form part of a compartment 266 enclosing the battery cell 208. In the event the battery cell 208 vents, gas can be discharged through the cell exhaust vent 240 on the side wall 264. In some embodiments, the cell exhaust vent 240 can be selectively opened under different pressure conditions to discharge internal gas, while when not open, it can at least mitigate an influence of gas outside the compartment on the battery cell 208. This arrangement can also save the size of the battery pack in a specified direction to a certain extent while allowing smooth gas discharge, improving space utilization. In some embodiments, the battery cell 208 can be a pouch cell, which may or may not be provided with structures such as score lines. Under specific operating conditions, the exhaust gas may be discharged through any weak part of the battery cell 208 and be discharged to other parts of the battery pack 200 through the cell exhaust vent 240 on the side wall 264 facing the first side surface 260 of the battery cell 208.

According to yet another aspect of the present disclosure, and referring to FIG. 1, a vehicle 10 is also provided, that has the battery pack 100, 200 as described in any of the preceding embodiments. It should be understood that, provided they do not conflict with each other, all the implementations, features, and advantages described above for the battery packs 100, 200 according to the present disclosure are equally applicable to the vehicle 10 according to this other aspect of the present disclosure. That is, all the embodiments and their variations described above can be directly transferred, applied, and incorporated herein. For the sake of brevity of this disclosure, they are not repeated here.

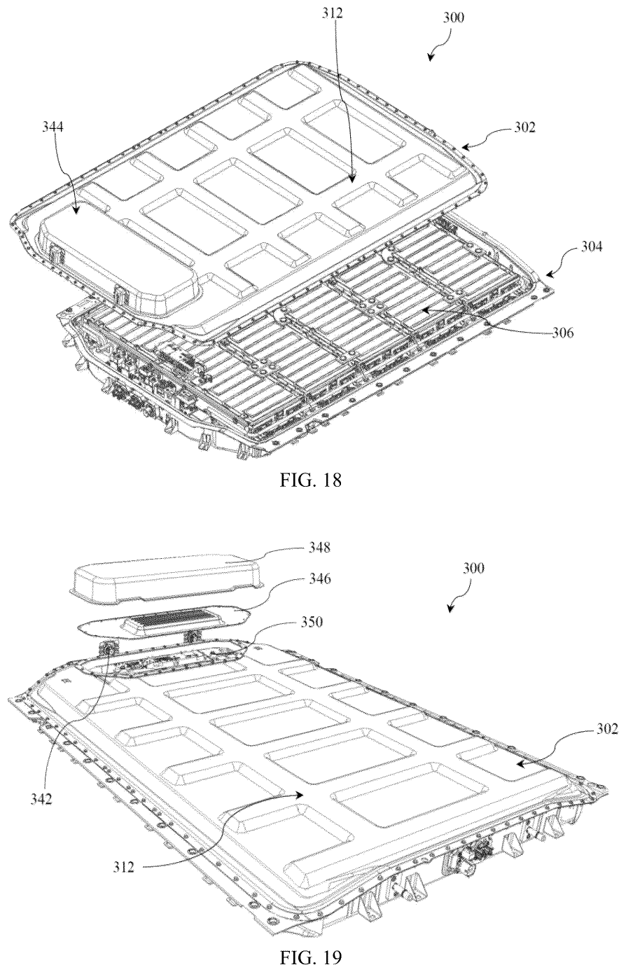

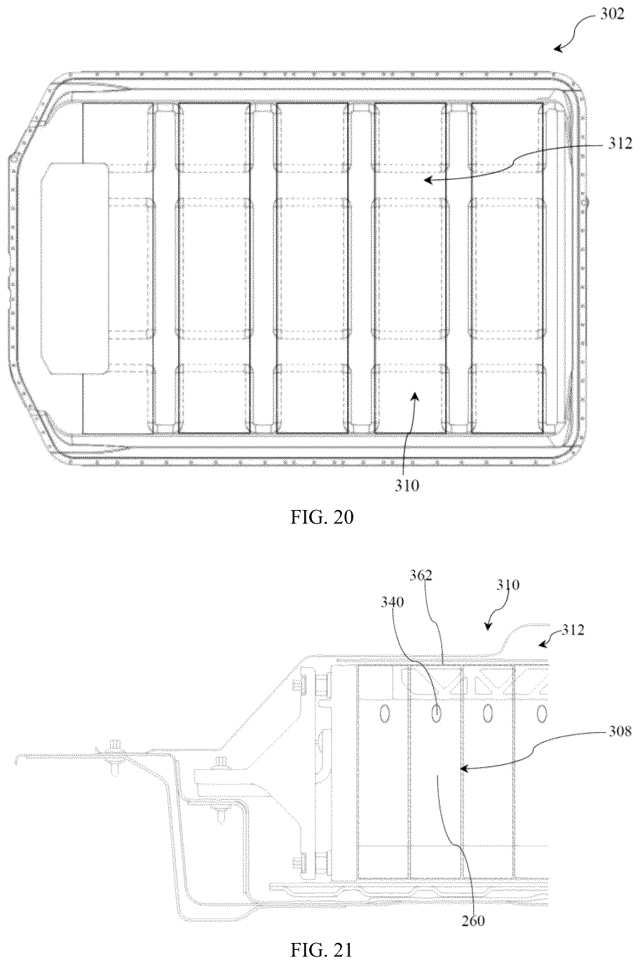

According to still another aspect of the present disclosure, and referring to FIGS. 17 to 21, a vehicle 20 is also provided, comprising a battery pack 300. For the sake of brevity, only some features of the battery pack 300 are described below; where compatible, other features of the battery pack 300 can be referred to the foregoing description regarding the battery pack 100. The battery pack 300 comprises a first battery array 306 and an upper cover 302. The first battery array 306 comprises several battery cells 308. The upper cover 302 is located above the first battery array 306 in the vertical direction and comprises a first side portion 310, the first side portion 310 being adjacent to the upper side surfaces 362 of the several battery cells 308 in the first battery array 306. The first side portion 310 is provided with a first ventilation channel 312 for collecting exhaust gas from the battery cells 308, and at least a portion of the first ventilation channel 312 is isolated from the first battery array 306 in the vertical direction of the vehicle 20.

In the embodiment of the vehicle 20, directional expressions such as “longitudinal,” “vertical direction,” “above,” etc., are related to the installed state of the battery pack and the vehicle to which it is installed. For example, “longitudinal” may substantially correspond to the longitudinal direction of the vehicle 20 to which the battery pack 300 is installed, or the front-rear direction of the vehicle; “above” may substantially correspond to the vertically upward direction of the vehicle 20; “below” may substantially correspond to the vertically downward direction of the vehicle 20, and so forth.

In the embodiment of the vehicle 20, the first ventilation channel 312, responsible for collecting and guiding gas that may be generated during operation of the battery cells 308 in the battery pack 300, is arranged above the battery cells 308. Because the first side portion 310 is adjacent to the upper side surface 362 of the battery cells 308, the gas is diverted from the discharge location of the battery cell 308 to another side surface. This can save the size of the battery pack in the vertical direction to a certain extent while discharging gas, reducing the space occupied by the battery pack 300 in the vertical direction inside the vehicle 20.

Referring to FIG. 19, the battery pack 300 further comprises a vent valve 342 located at an end in the longitudinal direction of the vehicle 20—for example, the rear end. The first ventilation channel 312 communicates with the vent valve 342 via a first chamber 344. This arrangement allows the exhaust gas collected in the first ventilation channel 312 from inside the battery pack 300 to be ultimately discharged to the external environment through the vent valve 342 located at the end in the longitudinal direction of the vehicle 20. The first chamber 344 can collect exhaust gas from the entire interior of the battery pack 300 and ultimately distribute it to one or more vent valves 342 for discharge to the external environment.

Referring to FIG. 19, in some embodiments, the first chamber 344 may further comprise a first cover plate 346 for separating the first chamber 344 from a battery control unit 350, and a second cover plate 348 for separating the first chamber 344 from the external environment. The arrangement of the first cover plate 346 and the second cover plate 348 can provide maintenance access to the battery control unit 350 when needed, while also providing isolation means for the battery control unit 350 to protect it from the effects of exhaust gas.

In conclusion, compared with the prior art, the present disclosure proposes a battery pack. The technical solution of the present disclosure, relative to the prior art, can provide a smooth discharge path for gas generated inside the battery pack while making the overall structure of the battery pack as compact as possible, thereby improving user satisfaction.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned embodiments are possible examples of implementations of the present disclosure and are given only for the purpose of enabling those skilled in the art to clearly understand the principles of the present disclosure. It should be understood by those skilled in the art that the above discussion to any embodiment is only illustrative, and is not intended to imply that the disclosed scope of the embodiments of the present disclosure (including claims) is limited to these examples; and under the overall concept of the present disclosure, the technical features in the above embodiments or different embodiments can be combined with each other to produce many other changes in different aspects of embodiments of the present disclosure that is not provided in detailed description for the sake of brevity. Therefore, any omission, modification, equivalent replacement, etc. made within the spirit and principle of the embodiment of the present disclosure shall be included in the scope of protection claimed by the present disclosure.

It should be understood that, on the premise of technical feasibility, the technical features listed above for different embodiments can be combined with each other to form other embodiments within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises”, “comprising”, and “comprise”, respectively.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack, comprising:
an upper cover and a tray; and
a battery cell located within a space defined collectively by the upper cover and the tray, wherein the battery cell has a first side surface provided with a cell exhaust vent or facing the cell exhaust vent,
wherein the upper cover, the tray, or both includes a first side portion adjacent to a second side surface of the battery cell, the first side surface is adjacent to the second side surface, the first side portion is provided with a first ventilation channel configured to collect exhaust gas from the battery cell, at least a portion of the first ventilation channel is isolated from the battery cell.

2. The battery pack of claim 1, wherein the battery cell forms part of a first battery array and the battery pack further comprises a second battery array,
wherein the upper cover, the tray, or both further comprises a second side portion abutting the second battery array, the first ventilation channel extends to the second side portion,
wherein a second ventilation channel is formed between the first battery array and the second battery array, the first side surface of the battery cell of the first battery array faces the second ventilation channel, the second ventilation channel disposed at an angle to the first ventilation channel and in communication with the first ventilation channel.

3. The battery pack of claim 2, wherein a first heat insulation plate is provided on a side of the first battery array and on a side of the second battery array facing the second ventilation channel.

4. The battery pack of claim 2, further comprising a bridge plate, wherein the first battery array and the second battery array respectively comprise a first end plate and a second end plate, the first end plate and the second end plate are connected by the bridge plate, the bridge plate closing an end of the second ventilation channel.

5. The battery pack of claim 4, wherein the first battery array and the second battery array are supported on the tray via the bridge plate.

6. The battery pack of claim 5, wherein the bridge plate comprises a first part closing the end of the second ventilation channel, a second part connected to the first part at an angle, and a support rib connected to both the first part and the second part at an angle, and the second part is supported on the tray.

7. The battery pack of claim 2, wherein the first side portion and the second side portion are located on the upper cover, and second heat insulation plates are respectively provided between the upper cover and the first battery array as well as between the upper cover and the second battery array.

8. The battery pack of claim 2, wherein the upper cover comprises a first plate and several second plates, each of the second plates abuts one of the first battery array and the second battery array, and the first plate and the second plates enclose to form at least a portion of the first ventilation channel.

9. The battery pack of claim 8, wherein the second ventilation channel is located between adjacent second plates and is at least partially defined by the first plate.

10. The battery pack of claim 1, further comprising a vent valve, wherein the first ventilation channel communicates with the vent valve.

11. The battery pack of claim 10, further comprising a first chamber provided between the first ventilation channel and the vent valve.

12. The battery pack of claim 11, wherein the first chamber comprises a first cover plate for separating the first chamber from a battery control unit, and a second cover plate for separating the first chamber from external environment.

13. The battery pack of claim 11, further comprising a cover plate covering the vent valve, the cover plate comprising an air passage communicating the vent valve with external environment.

14. The battery pack of claim 13, wherein the air passage is located on a side of the cover plate and is inclined downward.

15. The battery pack of claim 11, wherein the first chamber is located at a longitudinal end of the battery pack, and the vent valve is located on a wall of the first chamber facing the longitudinal exterior.

16. The battery pack of claim 4, wherein the first battery array comprises a first side plate connected to the first end plate, the second battery array comprises a second side plate connected to the second end plate, and the bridge plate passes through the first end plate and the second end plate respectively to connect to the first side plate and the second side plate.

17. A vehicle, comprising a battery pack of claim 1.

18. A vehicle, comprising:
a battery pack, the battery pack comprising:
a first battery array comprising several battery cells; and
an upper cover located above the first battery array in a vehicle vertical direction, the upper cover comprising a first side portion adjacent to an upper side surface of the several battery cells in the first battery array,
wherein the first side portion is provided with a first ventilation channel for collecting exhaust gas from the battery cells, and at least a portion of the first ventilation channel is isolated from the first battery array in the vehicle vertical direction.

19. The vehicle of claim 18, wherein the battery pack further comprises a vent valve located at an end in a vehicle longitudinal direction, and the first ventilation channel communicating with the vent valve via a first chamber.

20. The vehicle of claim 19, wherein the first chamber comprises a first cover plate for separating the first chamber from a battery control unit, and a second cover plate for separating the first chamber from external environment.
